(19) United States
(12) Patent Application Publication
(10) Pub. No.: US 2019/0201989 A1
(43) Pub. Date: Jul. 4, 2019

(54) MOLDING CUTTER

(71) Applicant: JI ZHUN PRECISION INDUSTRY (HUI ZHOU) CO., LTD., Huizhou (CN)

(72) Inventors: LONG XU, Shenzhen (CN); YI-MIN JIANG, Shenzhen (CN); JUN-QI LI, Shenzhen (CN)

(21) Appl. No.: 16/213,845

(22) Filed: Dec. 7, 2018

(30) Foreign Application Priority Data
Sep. 27, 2018 (CN) 201811133368.X

(51) Int. Cl. B23C 5/10

(52) U.S. Cl. CPC B23C 5/10

(57) ABSTRACT

A molding cutter includes a cutter bar and a cutter head. The cutter head is mounted on one end of the cutter bar. The cutter head includes a main body and a number of cutter teeth. The main body includes a first end face, a second end face, and a curved surface. The first end face is coupled to the cutter bar, and the curved surface is coupled between the first end face and the second end face. The cutter teeth are mounted on the curved surface. A quantity of the number of cutter teeth is equal to a positive integer within a range from 8 to D*15. D is equal to a diameter of the main body of the cutter head in millimeters.

### FIELD

The subject matter herein generally relates to cutter teeth, and more particularly to a molding cutter.

### BACKGROUND

Cutting devices for processing hard and brittle materials, such as graphite, ceramic, glass, carbon fiber, and hard alloy, generally use diamond blades. However, such cutting devices generally have a low number of blades which results in coarse cutting and a low life of the cutting device.

### BRIEF DESCRIPTION OF THE DRAWINGS

Implementations of the present disclosure will now be described, by way of embodiments, with reference to the attached figures.

FIG. 1 is a partial isometric view of an embodiment of a molding cutter.

FIG. 2 is a side view of the molding cutter in FIG. 1.

FIG. 3 is a top view of the molding cutter in FIG. 1.

FIG. 4 is a diagram of a first embodiment of a cutter tooth of the molding cutter in FIG. 1.

FIG. 5 is a diagram of a second embodiment of a cutter tooth of the molding cutter in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

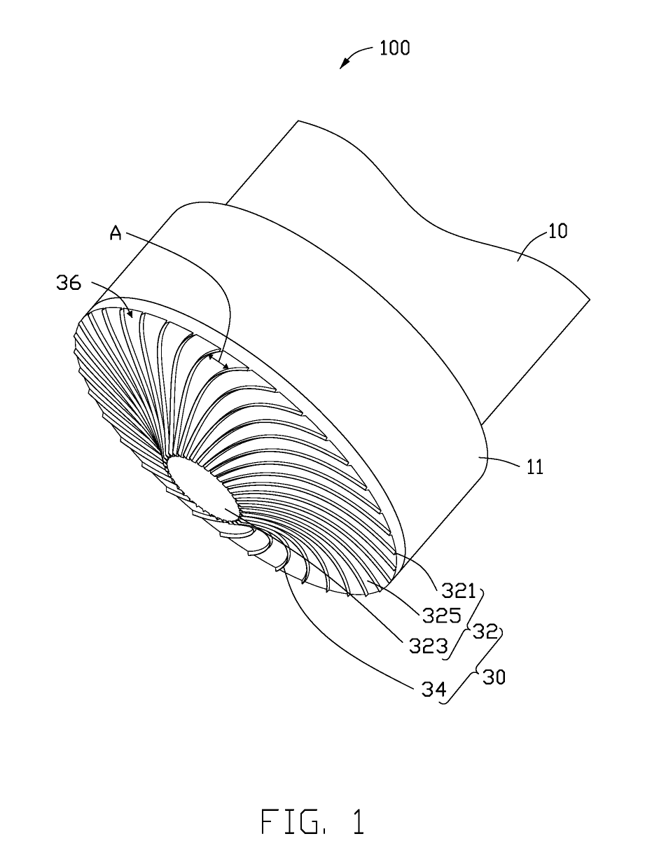

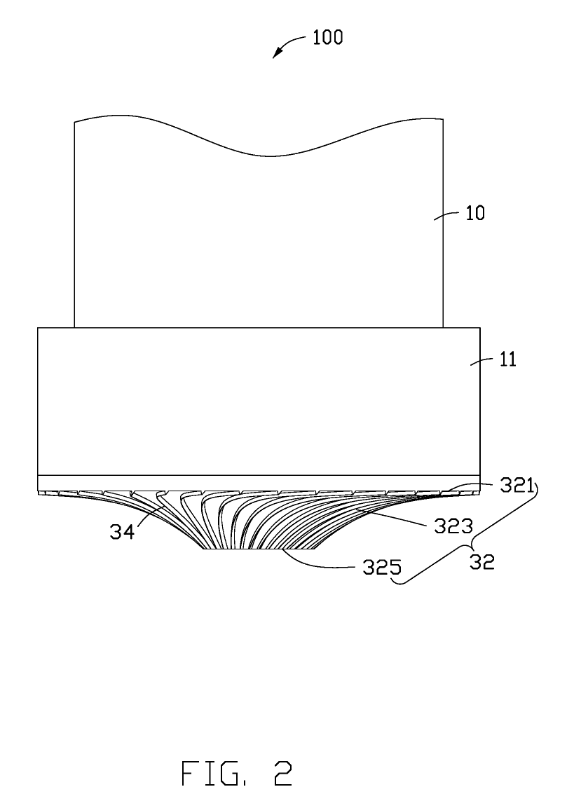

FIGS. 1-3 show an embodiment of a molding cutter 100 for processing a work piece. The molding cutter 100 includes a cutter bar 10 and a cutter head 30. The cutter head 30 is coupled to an end of the cutter bar 10.

The cutter bar 10 is externally coupled to a processing device (not shown in figures) for driving the molding cutter 100 to move and rotate. The cutter bar 10 is substantially cylindrical. In one embodiment, the cutter bar 10 includes a projection 11. The projection 11 is located at an end of the cutter bar 10 and is coupled to the cutter head 30. A radius of the projection 11 is the same as a radius of the cutter head 30 and is larger than a radius of the cutter bar 10. The cutter bar 10 is made of hard alloy, high-speed steel, or the like.

The cutter head 30 is coupled to the end of the cutter bar 10. The cutter head 30 may be made of diamond, polycrystalline diamond, chemical vapour diamond, microcrystalline diamond, polycrystalline cubic boron nitride, or ceramic.

The cutter head 30 includes a main body 32 and a plurality of cutter teeth 34. The main body 32 includes a first end face 321, and second end face 323, and a curved surface 325. The first end face 321 is mounted to an end surface of the cutter bar 10. A diameter of the first end face 321 is greater than a diameter of the second end face 323. The first end face 321 is a lateral side of the main body 32. The curved surface 325 is curved and coupled between the first end face 321 and the second end face 323. In one embodiment, the second end face 323 is located axially on the main body 32, and the first end face 321 is substantially perpendicular to the second end face 323.

The plurality of cutter teeth 34 are spaced apart on the curved surface 325. A first end of each of the cutter teeth 34 is adjacent the first end face 321, and a second end opposite to the first end of each of the cutter teeth 34 is adjacent the second end face 323.

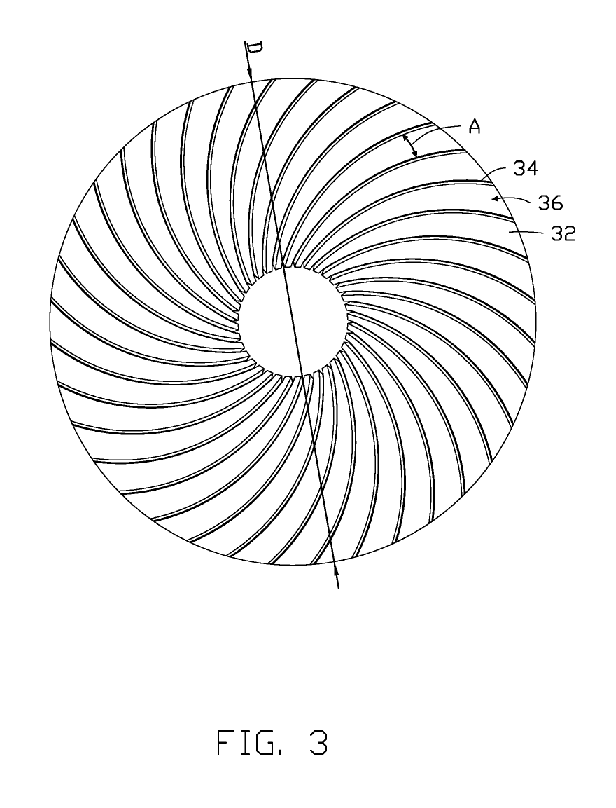

As shown in FIG. 3, a quantity of the plurality of cutter teeth 34 is a positive integer in a range between 8 and D*15. D is a diameter of the main body 32 of the cutter head 30 in millimeters. In one embodiment, the quantity of the plurality of cutter teeth 34 is equal to 36.

Every two adjacent cutter teeth 34 cooperatively define a groove 36. A groove width A of the groove 36 is between 0.01 and 2.0 millimeters. A base of the groove 36 may be a curved surface or may be a flat surface.

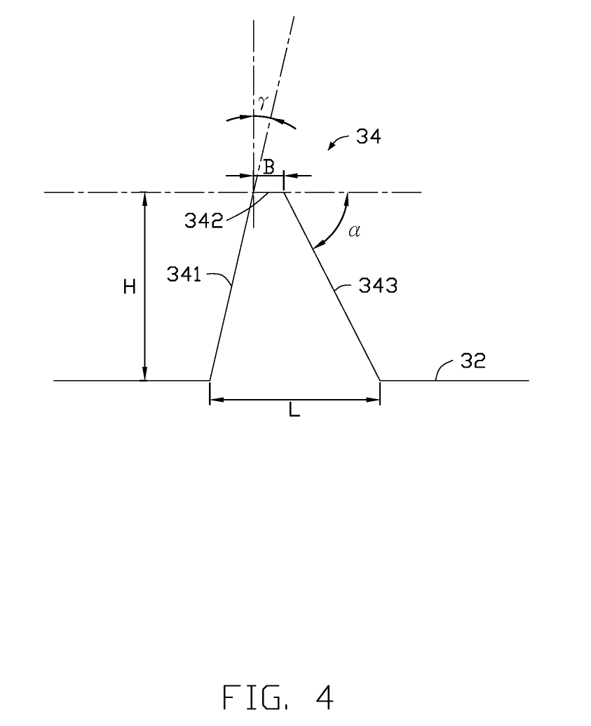

As shown in FIG. 4, each of the cutter teeth 34 includes a front cutter tooth surface 341, a blade edge 342, and a rear cutter tooth surface 343 connected in sequence. The front cutter tooth surface 341 and the rear cutter tooth surface 343 are coupled to the main body 32. The blade edge 342 is coupled between the front cutter tooth surface 341 and the rear cutter tooth surface 343 and is opposite to the main body 32 and is configured for cutting a workpiece.

In one embodiment, a cutter tooth height H between the blade edge 342 and the main body 32 is between 0.001 millimeters and 0.5 millimeters.

In one embodiment, a blade width B of the blade edge 342 is between 0 and 0.1 millimeter.

In one embodiment, a cutter tooth width L between the front cutter tooth surface 341 and the rear cutter tooth surface 343 on the main body 32 is between 0.001 and 1.0 millimeter.

In one embodiment, an anterior angle γ of the front cutter tooth surface 341 relative to a normal plane of the main body 32 is between −40 degrees and 20 degrees.

In one embodiment, a posterior angle α of the rear cutter tooth surface 343 relative to a tangent plane of the blade edge parallel to a tangent plane of the main body 32 is between 0 degrees and 90 degrees.

In one embodiment, the cutter teeth 34 are helically arranged on the main body 32. The cutter teeth 34 may be left-helix oriented, right-helix oriented, or a combination of left and right-helix oriented.

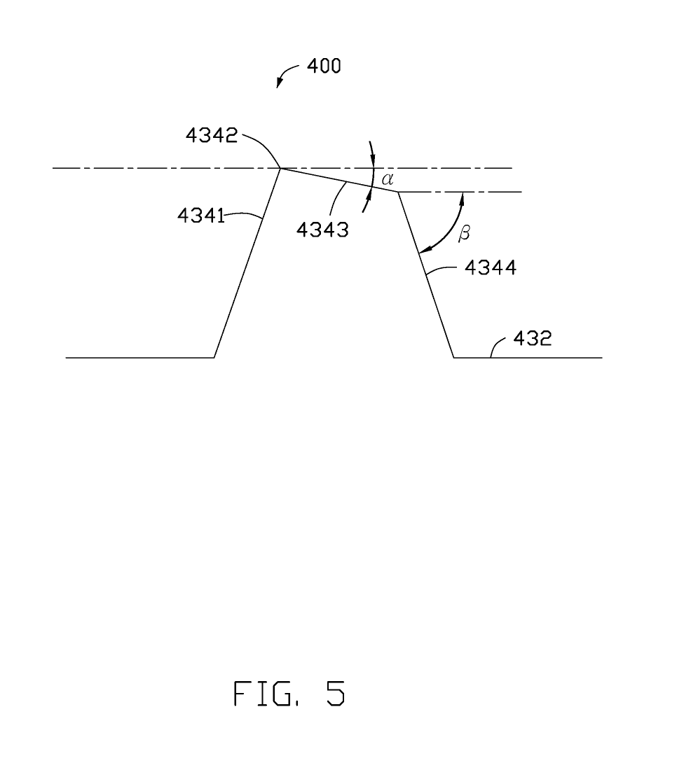

FIG. 5 shows a second embodiment of a molding cutter 400. A difference between the second embodiment and the first embodiment is that the cutter teeth 434 of the molding cutter 400 include a front cutter tooth surface 4341, a blade edge 4342, a first rear cutter tooth surface 4343, and a second rear cutter tooth surface 4344 connected in sequence. The front cutter tooth surface 4341 and the second rear cutter tooth surface 4344 are coupled to a main body 432. A second posterior angle β of the second rear cutter tooth surface 4344 relative to the tangent plane of the blade edge parallel to a tangent plane of the main body 432 is between 0 degrees and 90 degrees. The posterior angle α is between 0 degrees and 90 degrees.

Embodiments of the molding cutter 100/400 as described above include the main body 32/432 mounting the plurality of cutter teeth 34/434. The quantity of the plurality of cutter teeth 34/434 is equal to a positive integer in a range between 8 and D*15. D is equal to the diameter of the main body 32/432 in millimeters. Thus, the molding cutter 100/400 can process a workpiece such as graphite, ceramic, or other hard material with an enhanced feed rate and efficiency. Furthermore, a life of the molding cutter 100/400 may be extended.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A molding cutter comprising:
a cutter bar; and
a cutter head mounted on one end of the cutter bar, the cutter head comprising:
a main body comprising a first end face, a second end face, and a curved surface, the first end face being coupled to the cutter bar, the curved surface being coupled between the first end face and the second end face; and
a plurality of cutter teeth each mounted on the curved surface, a quantity of the plurality of cutter teeth equal to a positive integer within a range from 8 to D*15, wherein D is equal to a diameter of the main body of the cutter head in millimeters.

2. The molding cutter of claim 1, wherein the cutter head is made of diamond, cubic boron nitride, ceramic, or any hard alloy.

3. The molding cutter of claim 1, wherein each of the plurality of cutter teeth comprises a blade edge; a shortest distance between the blade edge and the main body is between 0.001 and 0.5 millimeters.

4. The molding cutter of claim 3, wherein:
each of the plurality of cutter teeth comprises a blade edge; and
a width of the blade edge is less than 0.1 millimeter.

5. The molding cutter of claim 4, wherein:
each of the plurality of cutter teeth comprises a front cutter tooth surface; and
an anterior angle of the front cutter tooth surface relative to a normal plane of the main body is between −40 degrees and 20 degrees.

6. The molding cutter of claim 5, wherein:
each of the plurality of cutter teeth comprises a rear cutter tooth surface; and
a posterior angle of the rear cutter tooth surface relative to a tangent plane of the blade edge parallel to a tangent plane of the main body is between 0 degrees and 90 degrees.

7. The molding cutter of claim 6, wherein:
each of the plurality of cutter teeth comprises the front cutter tooth surface, a blade edge, and the rear cutter tooth surface coupled in sequence;
the front cutter tooth surface and the rear cutter tooth surface are coupled to the main body;
the blade edge is coupled between the front cutter tooth surface and the rear cutter tooth surface and is opposite the main body.

8. The molding cutter of claim 6, wherein:
each of the plurality of cutter teeth comprises the front cutter tooth surface, a blade edge, the rear cutter tooth surface, and a second rear cutter tooth surface coupled in sequence;
the front cutter tooth surface and the second rear cutter tooth surface are coupled to the main body;
the blade edge is coupled between the front cutter tooth surface and the rear cutter tooth surface and is opposite the main body.

9. The molding cutter of claim 1, wherein each adjacent two of the plurality of cutter teeth cooperatively define a groove having a width between 0.01 and 2.0 millimeters.

10. The molding cutter of claim 1, wherein:
the first end face is a side surface of the cutter head, and the second end face is an end surface of the cutter head; and
the first end face is perpendicular to the second end face.
